(19) United States
(12) Patent Application Publication
(10) Pub. No.: US 2019/0069114 A1
(43) Pub. Date: Feb. 28, 2019

(54) AUDIO PROCESSING DEVICE AND AUDIO PROCESSING METHOD THEREOF

(71) Applicant: Acer Incorporated, New Taipei City (TW)

(72) Inventors: Kuei-Ting TAI, New Taipei City (TW); Jia-Ren CHANG, New Taipei City (TW); Ming-Chun YU, New Taipei City (TW)

(21) Appl. No.: 15/983,664

(22) Filed: May 18, 2018

(30) Foreign Application Priority Data
Aug. 31, 2017 (TW) 106130068

(51) Int. Cl. H04S 7/00; H04S 3/00

(52) U.S. Cl. CPC H04S 7/301; H04S 7/304; H04S 2400/11; H04S 2400/01; H04S 3/008

(57) ABSTRACT

The present disclosure provides an audio processing device including a positioning unit and a digital signal processor. The positioning unit detects the original position and the up-to-date position and calculates an offset between the up-to-date position and the original position. The digital signal processor, electrically connected to the positioning unit, receives audio data to generate a surround sound field having a plurality of virtual speaker sound effects and receives the offset to adjust the virtual speaker sound effects of the surround sound field according to the offset.

### CROSS REFERENCE TO RELATED APPLICATIONS

The present application is based on, and claims priority from, Taiwan Application Number 106130068, filed Aug. 31, 2017, the disclosure of which is hereby incorporated by reference herein in its entirety.

### BACKGROUND OF THE INVENTION

### Field of the Invention

The present disclosure relates to an audio processing device, and in particular it relates to an audio processing device and a method thereof for changing a sound field as a user changes position.

### Description of the Related Art

At present, when a user watches a movie, plays a video game or uses a Virtual Reality (VR) device using a general audio/video (A/V) equipment, as shown in FIG. 1, no matter whether the position of the user 100 changes relative to a curved screen 110 or not, the volume of the sound heard by the user 100 through a headphone 120 is the same. No matter whether the headphone 120 or another physical speaker is used, the generated sound field will not change as the position of the user 100 changes. As a result, the direction of the sound field of the A/V content felt by the user 100 may not be correct.

### BRIEF SUMMARY OF THE INVENTION

The present disclosure provides an audio processing device and a method thereof for changing a sound field as the user changes position.

The present disclosure provides an audio processing device comprising a positioning unit and a digital signal processor. The positioning unit detects the original position and the up-to-date position and calculates the offset between the up-to-date position and the original position. The digital signal processor, electrically connected to the positioning unit, receives audio data to generate a surround sound field having a plurality of virtual speaker sound effects and receives the offset to adjust the virtual speaker sound effects of the surround sound field according to the offset.

The present disclosure further provides an audio processing method for an audio processing device. The audio processing method comprises receiving audio data at a digital signal processor of the audio processing device to generate a surround sound field having a plurality of virtual speaker sound effects; detecting the original position and the up-to-date position using a positioning unit of the audio processing device; calculating the offset between the up-to-date position and the original position; and receiving the offset at the digital signal processor, and adjusting the virtual speaker sound effects of the surround sound field according to the offset.

### BRIEF DESCRIPTION OF THE DRAWINGS

The present disclosure can be more fully understood by reading the subsequent detailed description and examples with references made to the accompanying drawings, wherein:

FIG. 1 is a schematic diagram showing a user using general A/V equipment.

FIG. 2A schematically shows a block diagram of an audio processing device according to a first embodiment of the present disclosure.

FIG. 2B schematically shows a block diagram of an audio processing device according to a second embodiment of the present disclosure.

FIG. 3A and FIG. 3B schematically shows the relative position of the user, the audio processing device and the screen.

FIG. 4 schematically shows a flow chart of an audio processing method according to the first embodiment of the present disclosure.

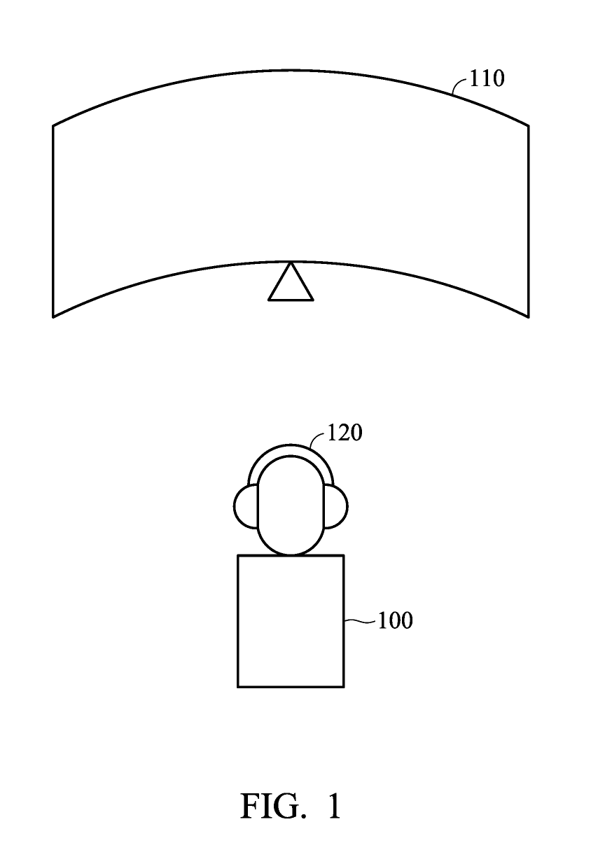

### DETAILED DESCRIPTION OF THE INVENTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

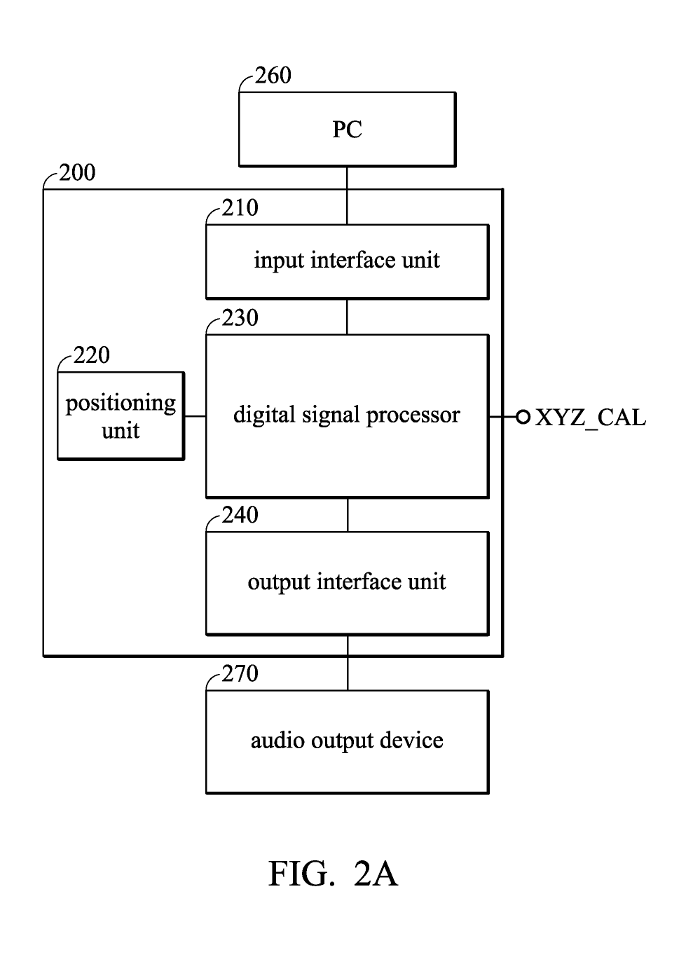

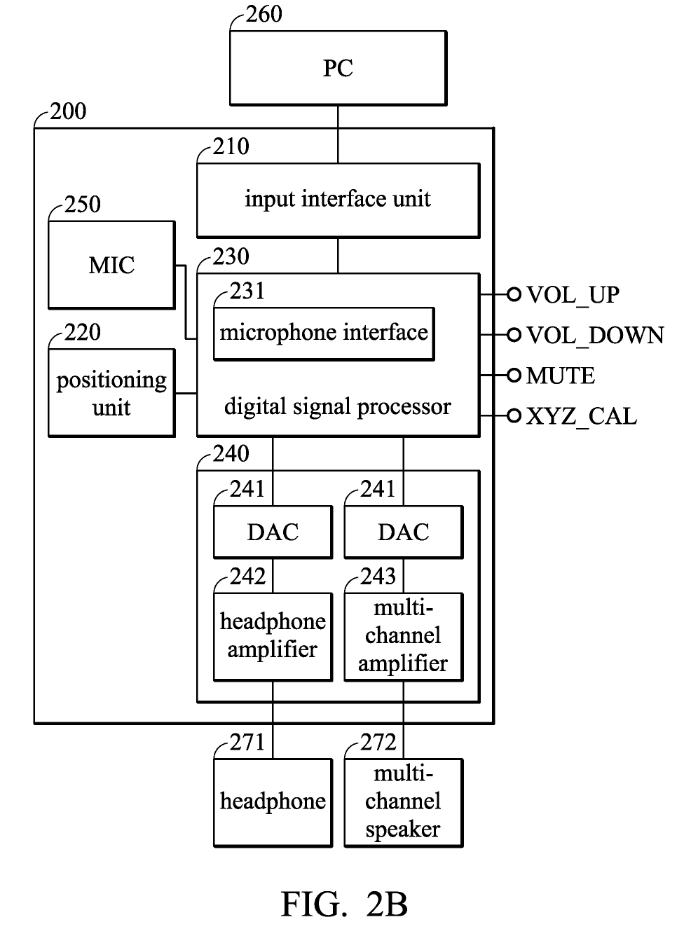

FIG. 2A schematically shows a block diagram of an audio processing device 200 according to a first embodiment of the present disclosure. The audio processing device 200 mainly includes an input interface unit 210, a positioning unit 220, a digital signal processor 230 and an output interface unit 240. The audio processing device 200 receives audio/video data (A/V data) from a personal computer (PC) 260. After being processed by the audio processing device 200, the audio output device 270 outputs the audio to a user (not shown). The audio processing device 200 may be a headphone, a gaming headphone, smart glasses, a head mounted display, a head mounted virtual reality device, or a wearable device.

In this embodiment, according to the A/V content played by the user, the personal computer 260 sends the A/V data to the audio processing device 200 via a universal serial bus (USB), a high definition multimedia interface (HDMI) or other transmission interface that can transfer the A/V data. The personal computer 260 may also directly send audio data to the audio processing device 200. In other embodiments, the audio processing device 200 may also receive the A/V data or the audio data from game consoles, multimedia players (such as DVD players and Blu-ray Disc players), portable music players, smartphones, tablets and notebooks, but it is not limited thereto.

The input interface unit 210 receives the A/V data from the personal computer 260, and converts the A/V data into image data and audio data. The image data are displayed by a display device after necessary processing, and the audio data are sent to the digital signal processor 230. The audio data can be stereo two-channel audio data. When the personal computer 260 transmits the audio data, the input interface unit 210 directly transmits the audio data to the digital signal processor 230 without conversion. The audio data may be transmitted to the digital signal processor 230 through any audio format interface such as Integrated Interchip Sound (I²S), High Definition Audio (HDA) and Pulse-Code Modulation (PCM).

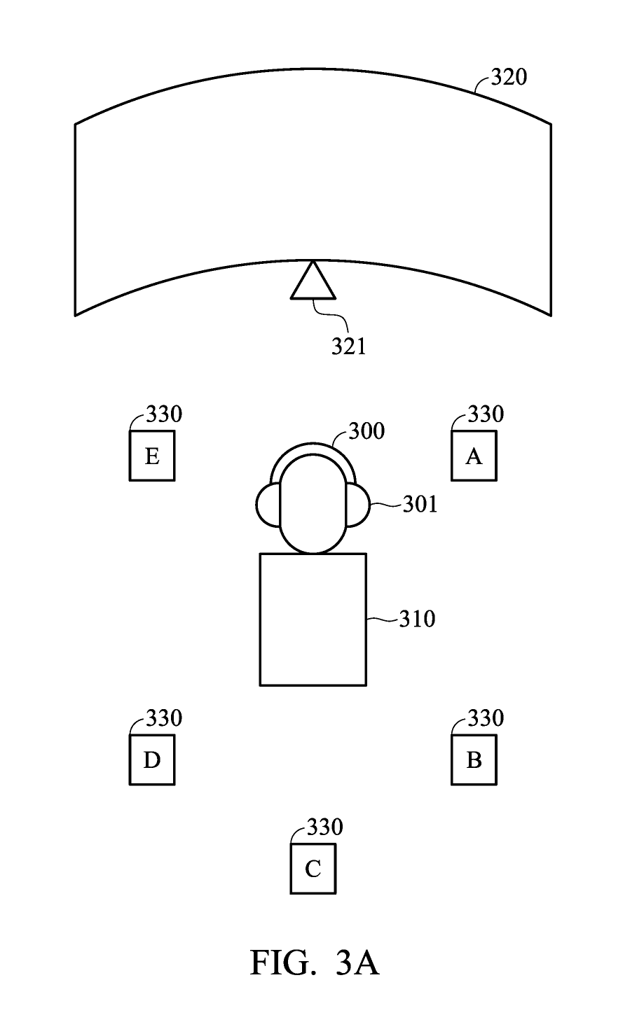

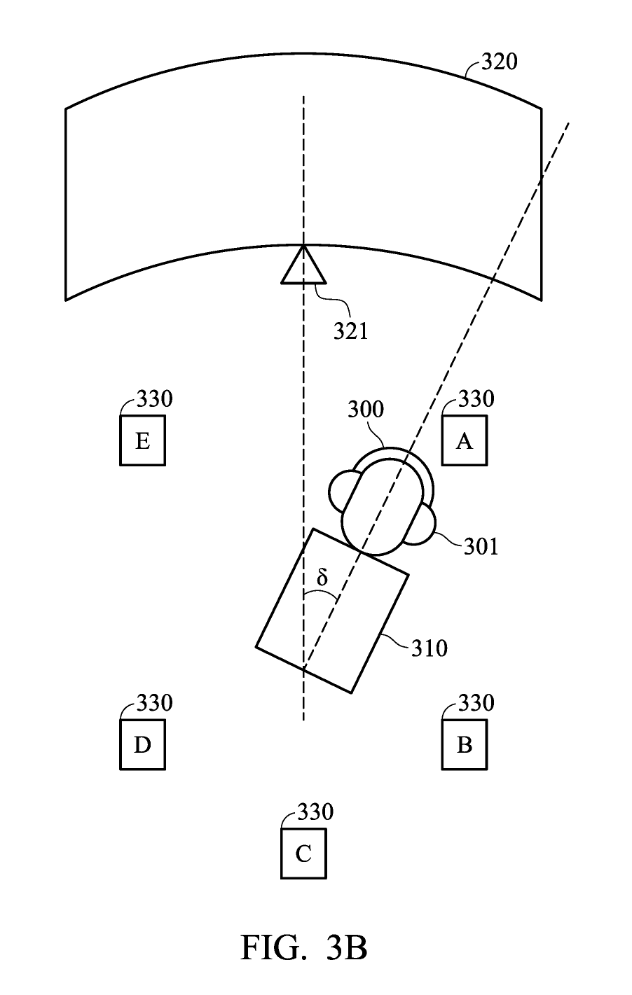

The positioning unit 220 is a nine-axis sensor constituted by a three-axis Accelerometer, a three-axis Magnetometer and a three-axis Gyroscope for detecting the user's up-to-date position and the original position. The user's position information detected by the positioning unit 220 may be defined according to a Cartesian coordinate system, a polar coordinate system, or a cylindrical coordinate system, but it is not limited thereto. When the positioning unit 220 receives a calibration instruction (XYZ_CAL) from the user via the digital signal processor 230, the positioning unit 220 sets the current position of the user to the original position (X, Y, Z). Then, the positioning unit 220 continues to detect whether the user has rotation or movement. If the user rotates or moves, the positioning unit 220 detects the up-to-date position (X1, Y1, Z1) and calculates an offset (X1-X, Y1-Y, Z1-Z) between the up-to-date position and the original position. The positioning unit 220 transmits the offset to the digital signal processor 230. The method for receiving the calibration instruction from the user includes that setting a button on the audio processing device 200 or setting an input option in the software interface of the personal computer 260 for the user inputting the calibration instruction and sending to the digital signal processor 230. Taking FIG. 3A as an example, when the user wears the headphone 300 facing the center (or a predetermined area) of the screen 320 and inputs the calibration instruction, the positioning unit detects the user's current position as the original position. After that, if the user moves or rotates, the latest position after moving or rotating is detected to obtain the offset between the up-to-date position and the original position.

The digital signal processor 230 may be a codec which electrically connected to the input interface unit 210 and the positioning unit 220. The digital signal processor 230 receives the audio data to generate a virtual surround sound having a plurality of virtual speaker sound effects. The digital signal processor 230 utilizes the listening effect of human ears to create a virtual surround sound source located in the rear side or the side of the user from a plurality of virtual speakers by using the simulation methods of sound localization. The simulation methods includes using the sound intensity, phase difference, time difference and the Head Related Transfer Function (HRTF) to generate the virtual surround sound field, which is not described in detail herein. For example, the digital signal processor 230 can generate a surround sound field of five virtual speaker sound effects in different directions, and adjust the gain and/or the output intensity of the specific virtual speaker for different directions respectively.

The digital signal processor 230 receives the offset from the positioning unit 220, and adjusts the virtual speaker sound effects of the surround sound field according to the offset. The digital signal processor 230 calculates the offset and converts the offset to an offset angle. The digital signal processor 230 determines whether the offset angle is greater than a predetermined angle (e.g., 5 degrees). If the offset angle is greater than the predetermined angle, the digital signal processor 230 adjusts the virtual speaker sound effects. If the offset angle is less than or equal to the predetermined angle, the digital signal processor 230 does not adjust the virtual speaker sound effects. The digital signal processor 230 correspondingly adjusts the gain of the virtual speaker sound effects and/or the output intensity of the virtual speaker sound effects according to the offset angle.

The output interface unit 240 receives the surround sound field processed by the digital signal processor 230 to be output to the audio output device 270. The output interface unit 240 includes a Digital-to-Analog Converter (DAC) (not shown) for converting the digital signal of the surrounding sound field into an analog signal and transmitting the analog signal to an amplifier (not shown). Then, the amplifier outputs the analog signal to the audio output device 270.

The audio output device 270 may be a stereo headset, a headphone, a two-channel speaker, a multi-channel speaker and the like, but it is not limited thereto. The audio output device 270 receives the surround sound field from the output interface unit 240 and plays it to the user through a two-channel speaker or a multi-channel speaker.

FIG. 2B schematically shows a block diagram of an audio processing device 200 according to a second embodiment of the present disclosure. The audio processing device 200 mainly includes an input interface unit 210, a positioning unit 220, a digital signal processor 230, an output interface unit 240 and a microphone 250. In this embodiment, elements having the same names as those in the first embodiment also have the same functions as described above, and details are not described herein again. The main difference between FIG. 2B and FIG. 2A is that the audio processing device 200 further includes a microphone (MIC) 250 for receiving sound data from outside or from the user. The digital signal processor 230 further includes a microphone interface 231 for receiving the sound data from the microphone 250. The sound data can be transmitted to the PC 260 for further processing or outputted to a headphone 271 or a multi-channel speaker 272 through the output interface unit 240. The microphone interface 231 may be an interface which integrated a Pulse-Density Modulation and an Analog to Digital Converter (ADC). In addition, the digital signal processor 230 can receive setting instructions from the user. The setting instructions include functions such as volume up (VOL_UP), volume down (VOL_DOWN) and mute (MUTE). The user's setting instructions can be set through a plurality of buttons provided on the audio processing device 200 or a plurality of input options in the software interface of the personal computer 260 for the user to input the personalized setting instructions. Therefore, the audio-visual function of the audio processing device 200 is further improved.

In addition, in this embodiment, the output interface unit 240 further includes a plurality of digital to analog converters (DAC) 241, a headphone amplifier 242 and a multi-channel amplifier 243 for outputting the surround sound field to the corresponding audio output device. The audio output device is a headphone 271 or a multi-channel speaker 272. The digital signal processor 230 selects whether to output the surround sound field to the corresponding headphone 271 or multi-channel speaker 272 via the headphone amplifier 242 or multi-channel amplifier 243 according to the audio output device used by the user. The headphone 271 may be a stereo two-channel headphone or a two-channel speaker, and includes a left channel and a right channel output. The multichannel speaker 272 may be a multichannel speaker group such as 2.1 channel, 3.1 channel, 4.1 channel, 5.1 channel, 6.1 channel, 7.1 channel, 10.2 channel, 20.1 channel and the like, but it is not limited thereto. The multi-channel speaker 272 may surround the user's periphery to form a surround sound effect for the home theater.

FIG. 3A and FIG. 3B schematically show the relative position of the user 310, the audio processing device 300 and the screen 320. In this embodiment, the user 310 plays A/V content through a multimedia player (not shown) such as a personal computer, a game console or a mobile device, and the user 310 puts on the audio processing device 300 to watch a movie, play a video game or watch A/V content with the screen 320. The screen 320 may be a display device such as a curved screen, a liquid-crystal display, an OLED display and the like. The screen 320 may further include a screen stand 321 for supporting the screen 320. The audio processing device 300 receives the A/V content to create a surround sound field having a plurality of virtual speaker sound effects. The surround sound field is played to the user 310 via a stereo two-channel headphone 301, so that the user feels as if the virtual speakers set in the surrounding sound. In this embodiment, the audio processing device 300 virtualizes five virtual speakers 330 beside the user 310, and the virtual speakers are namely A to E, respectively. After the user 310 sets the calibration instruction of the audio processing device 300, the positioning unit of the audio processing device 300 sets the current position of the user 310 to the original position and continuously detects the up-to-date position of the user 310. In the schematic view of FIG. 3A, the original position of the user 310 is opposite the screen 320, and the offset angle is 0 degrees.

Next, referring to FIG. 3B, the user 310 rotates clockwise by an offset angle (δ) relative to the screen 320. The positioning unit of the audio processing device 300 detects the up-to-date position of the user 310 and calculates the offset between the up-to-date position and the original position. The positioning unit sends the offset to the digital signal processor of the audio processing device 300. The digital signal processor calculates an offset angle of the offset and determines whether the offset angle is greater than a predetermined angle. For instance, the predetermined angle is 5 degrees. If the offset angle is greater than 5 degrees, the surround sound field is changed using a preset gain mapping table (as shown in Table 1). Based on the gain mapping table, the gains of the virtual speakers A to E are respectively adjusted according to the offset angle of the user 310 to change different output intensities (in decibels, dB), so as to achieve the effect of changing the sound field. In one embodiment, when the user 310 rotates clockwise from 0 degrees to 60 degrees relative to the original position, the virtual speaker A increases from the original +6 dB to +9 dB; the virtual speaker B increases from the original +3 dB to +6 dB; the virtual speaker C increases from the original +0 dB to +3 dB; the virtual speaker D decreases from the original +3 dB to +0 dB; the virtual speaker E decreases from +6 dB to +3 dB.

TABLE 1
Gain mapping table corresponding to different offset angles

| Offset | | Virtual | | Virtual | | Virtual | | Virtual | | Virtual | |
|---|---|---|---|---|---|---|---|---|---|---|---|
| angle (δ) | | speaker A | | speaker B | | speaker C | | speaker D | | speaker E | |
| 0 | degrees | +6 | dB | +3 | dB | +0 | dB | +3 | dB | +6 | dB |
| 5 | degrees | +6.25 | dB | +3.25 | dB | +0.25 | dB | +2.75 | dB | +5.75 | dB |
| 10 | degrees | +6.5 | dB | +3.5 | dB | +0.5 | dB | +2.5 | dB | +5.5 | dB |
| . . . | | . . . | | . . . | | . . . | | . . . | | . . . | |
| 60 | degrees | +9 | dB | +6 | dB | +3 | dB | +0 | dB | +3 | dB |
| 120 | degrees | +6 | dB | +9 | dB | +6 | dB | +3 | dB | +0 | dB |
| 180 | degrees | +3 | dB | +6 | dB | +9 | dB | +6 | dB | +3 | dB |
| 240 | degrees | +0 | dB | +3 | dB | +6 | dB | +9 | dB | +6 | dB |
| 300 | degrees | +3 | dB | +0 | dB | +3 | dB | +6 | dB | +9 | dB |
| . . . | | . . . | | . . . | | . . . | | . . . | | . . . | |
| 350 | degrees | +5.5 | dB | +2.5 | dB | +0.5 | dB | +3.5 | dB | +6.5 | dB |
| 355 | degrees | +5.75 | dB | +2.75 | dB | +0.25 | dB | +3.25 | dB | +6.25 | dB |
| 360 | degrees | +6 | dB | +3 | dB | +0 | dB | +3 | dB | +6 | dB |

In Table 1, the corresponding output intensity of each offset angle is not specified in detail, but the corresponding output intensities of other offset angles should be understood by a person skilled in the art. Furthermore, it should be understood that, in this embodiment, the user 310 uses the headphone 301 to listen to the surround sound field. In other embodiments, the user 310 may replace the headphone 301 with a physical 5.1-channel speaker and play the surround sound field.

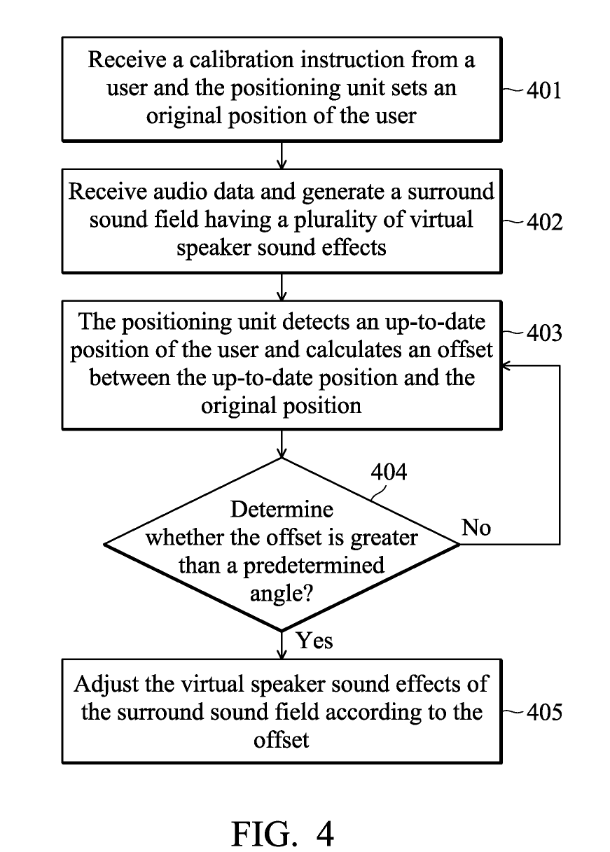

FIG. 4 schematically shows a flow chart of an audio processing method for an audio processing device according to the first embodiment of the present disclosure. Referring to FIG. 2A of the first embodiment of the present disclosure, in step 401, a calibration instruction from a user is received by the digital signal processor 230 of the audio processing device 200, and the positioning unit 220 sets the original position of the user. In step 402, audio data are received by the digital signal processor 230 of the audio processing device 200 to generate a surround sound field having a plurality of virtual speaker sound effects, and the audio data are outputted to the audio output device 270 and played to the user for listening. In step 403, the positioning unit 220 of the audio processing device 200 detects an up-to-date position of the user and calculates the offset between the up-to-date position and the original position. In step 404, the digital signal processor 230 determines whether the offset is greater than a predetermined angle. If the offset is less than or equal to the predetermined angle, the virtual speaker sound effects are not adjusted, and the flow chart returns to step 403. If the offset is greater than the predetermined angle, the flow chart proceeds to step 405. In step 405, the virtual speaker sound effects of the surround sound field are adjusted according to the offset by the digital signal processor 230. Wherein the virtual speaker sound effects are adjusted according to the user's offset angle, and the gain of the virtual speaker sound effects and/or the output intensity of the virtual speaker sound effects are adjusted correspondingly so as to achieve the effect of changing the surround sound field.

Further, in step 402, the method further includes A/V data are received by the input interface unit 210 of the audio processing device 200. The A/V data are converted into the audio data and sent to the digital signal processor 230 for subsequent processing. In addition, the surround sound field is also received by the output interface unit 240 of the audio processing device 200 to be output to the audio output device 270. The output interface unit 240 includes a headphone amplifier and a multi-channel amplifier for outputting the surround sound field to the corresponding audio output device 270. The audio output device 270 is a headphone or a multi-channel speaker. The digital signal processor 230 outputs the surround sound field to the corresponding headphone or the multi-channel speaker via the headphone amplifier or the multi-channel amplifier according to the audio output device 270.

Accordingly, through the audio processing device and the audio processing method of the present disclosure, when a user watches A/V content, the user can listen to not only the surround sound field but also the effect of changing the sound field according to the up-do-date position of the user. Allowing the user feels more immersive when watching a video, and has a better experience of watching A/V content.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An audio processing device, comprising:
a positioning unit, detecting an original position and an up-to-date position and calculating an offset between the up-to-date position and the original position;
a digital signal processor, electrically connected to the positioning unit, receiving audio data to generate a surround sound field having a plurality of virtual speaker sound effects and receiving the offset to adjust the virtual speaker sound effects of the surround sound field according to the offset.

2. The audio processing device as claimed in claim 1, wherein the digital signal processor receives a calibration instruction, and the positioning unit sets the original position when the digital signal processor receives the calibration instruction.

3. The audio processing device as claimed in claim 1, wherein the offset is an offset angle, and the digital signal processor determines whether the offset angle is greater than a predetermined angle, and if the offset angle is greater than the predetermined angle, the virtual speaker sound effects are adjusted.

4. The audio processing device as claimed in claim 3, wherein according to the offset angle, the digital signal processor correspondingly adjusts a gain of the virtual speaker sound effects and/or an output intensity of the virtual speaker sound effects.

5. The audio processing device as claimed in claim 1, further comprising:
an input interface unit, receiving audio/video (A/V) data, converting the A/V data into the audio data and sending the audio data to the digital signal processor.

6. The audio processing device as claimed in claim 1, further comprising:
an output interface unit, receiving the surround sound field to be output to an audio output device.

7. The audio processing device as claimed in claim 6, wherein the output interface unit includes a headphone amplifier and a multi-channel amplifier for outputting the surround sound field to the corresponding audio output device.

8. The audio processing device as claimed in claim 7, wherein the audio output device is a headphone or a multi-channel speaker, and the digital signal processor selects whether to output the surround sound field to the corresponding headphone or the multi-channel speaker via the headphone amplifier or the multi-channel amplifier according to the audio output device.

9. The audio processing device as claimed in claim 1, further comprising:
a microphone, wherein the digital signal processor further includes a microphone interface for receiving sound data from the microphone.

10. An audio processing method for an audio processing device, the audio processing method comprising:
receiving audio data at a digital signal processor of the audio processing device to generate a surround sound field having a plurality of virtual speaker sound effects;
detecting an original position and an up-to-date position of a user using a positioning unit of the audio processing device;
calculating an offset between the up-to-date position and the original position; and
receiving the offset at the digital signal processor, and adjusting the virtual speaker sound effects of the surround sound field according to the offset.

11. The audio processing method as claimed in claim 10, further comprising:
receiving a calibration instruction at the digital signal processor, and
using the positioning unit to set the original position of the user.

12. The audio processing method as claimed in claim 10, wherein the offset is an offset angle, and the digital signal processor determines whether the offset angle is greater than a predetermined angle, and if the offset angle is greater than the predetermined angle, the virtual speaker sound effects are adjusted.

13. The audio processing method as claimed in claim 12, wherein according to the offset angle, the digital signal processor correspondingly adjusts a gain of the virtual speaker sound effects and/or an output intensity of the virtual speaker sound effects.

14. The audio processing method as claimed in claim 10, further comprising:
receiving audio/video (A/V) data at an input interface unit of the audio processing device, converting the A/V data into the audio data, and sending the audio data to the digital signal processor.

15. The audio processing method as claimed in claim 10, further comprising:
receiving the surround sound field at an output interface unit of the audio processing device to be output to an audio output device.
